(19) United States
(12) Patent Application Publication
(10) Pub. No.: US 2002/0116310 A1
(43) Pub. Date: Aug. 22, 2002

(54) Computerized comparative investment analysis system and method

(76) Inventors: Jeffrey M. Cohen, Laguna Niguel, CA (US); John F. Nicodemo, Lake Forest, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/954,440

(22) Filed: Sep. 12, 2001

Related U.S. Application Data
(60) Provisional application No. 60/232,211, filed on Sep. 13, 2000.

(51) Int. Cl. G06F 17/60

(52) U.S. Cl. 705/36

(57) ABSTRACT

A system and method are provided that allow investors to perform an automated comparative analysis of a limitless number of investment opportunities on a tick by tick real-time basis. The comparative analysis is based on both objectively retrieved data and data subjectively inputted data by the investor. A result permitting comparison of investment opportunities is arrived at using a customized scoring criteria established by each investor for each type of stock portfolio. The system and method further permit the investor to monitor his or her portfolio and make appropriate adjustments based on the remaining profitability of current option positions and take appropriate measures to insure the portfolio against a major market correction.

This application claims priority under 35 U.S.C. § 119(e) to U.S. provisional application Serial No. 60/232,211 filed Sep. 13, 2000, the disclosure of which is hereby incorporated by reference in its entirety.

### FIELD OF THE INVENTION

A system and method are provided that allow investors to perform an automated comparative analysis of investment opportunities, including the sale of puts or calls the purchase of puts or calls, the purchase of stock, and the short sale of stock on a tick by tick real-time basis or on the basis of delayed data. The comparative analysis is based on both objective market data and subjective data from the investor. A result permitting comparison of investment opportunities is arrived at using a customized scoring criteria established by the investor for different classes of stock portfolio. The system and method further permit the investor to monitor his or her portfolio and make appropriate adjustments in holdings based on the remaining profitability of current option positions and take appropriate measures to insure the portfolio against a major market correction.

### SUMMARY OF THE INVENTION

Almost all investors have limited capital available for investment and at any given time they may have very limited resources to invest in any potential new opportunity. Consequently, it is important that investors make the very best educated investment choice as funds become available for investment.

In order to determine the best possible choice, one should compare all of the available opportunities based on the information currently available. In the stock market, this would require an investor to first assemble a reasonably large universe of potential stock candidates and then, as finds become available, review current value, growth and technical indicators about each of these potential stock candidates.

A problem arises, however, in that in a fast changing market, by the time the last stock has been thoroughly evaluated, the numbers for the first one have changed. It is literally impossible to manually perform a comparative analysis of more than just a few investment opportunities at any given time. As a result, investors have not previously had the necessary capability to perform a true comparative analysis on a large database of potential stock candidates, especially for use with sophisticated option strategies.

The system of the present invention addresses this dilemma. By automatically aggregating the objective value, growth and technical indicators and allowing subscribers to input their own, more static, subjective data, the system may indicate on a real-time basis the best investment opportunities, for various investment strategies. This comparison may be done on as many-companies as the subscriber wants to compare at any one time. The same indicators are used for the different strategies, but applied differently depending on the strategy. For instance, bearish versus bullish strategies would look for the opposite results from the value, growth and technical indicators, and option-buying strategies would be looking for low premiums versus high premiums for option selling strategies.

The system of the present invention provides subscribers a computerized comparative analysis tool which automates the process of determining the best investment opportunities, at any given time, taking into account various objective and subjective data and a weighted scoring system. The system aggregates value, growth and technical indicators for stocks inputted by subscribers and then, in conjunction with subjective data entered by the subscriber, scores the individual investment opportunities. This comparative approach can be used with any investment strategy because it provides an analysis of the stocks' current price to its historical price based on a number of different sets of data. The availability of option data provides additional help when considering strategies that involve the sale or purchase of options.

The system allows subscribers to subdivide their universe of stock opportunities into various portfolios based on any criteria and then develop customized scoring weights for the objective and subjective data which has been aggregated or inputted to these sub-portfolios. The companies within each portfolio are then sorted by descending score so that the best objectively developed investment opportunities rise to the top.

The system may be used with many different trading strategies such as the long purchase or short sale of stocks and various option strategies. Unlike existing “stock screeners” that merely create a universe of stocks that meet certain fundamental and/or technical criteria, the system evaluates and compares investment opportunities.

### BRIEF DESCRIPTION OF THE DRAWINGS

FIGS. 1-3 are flow charts illustrating the function and operation of the Evaluator portfolio module in assigning a score to a specific investment opportunity, thereby allowing a set of investment opportunities to be ranked by the quality of the investment.

FIGS. 4-5 are flow charts illustrating the function and operation of the Monitor module to alert the investor to potential close-out positions, and to determine how to insure a position by buying index puts, including how many index puts to buy and at what strike price.

FIGS. 6 and 7 are flow charts illustrating how individual indicator scores are normalized and aggregated to arrive at an individual indicator score for a stock.

FIG. 8 is a block diagram of the preferred embodiment of the invention.

FIGS. 9-11 are exemplary screen shots of an Evaluator portfolio grid and toolbar as displayed to the subscriber. In the illustrated embodiment, the Evaluator portfolio is a Naked Put Evaluator Portfolio.

FIG. 12 illustrates screen shots of windows displayed to the subscriber when an Evaluator portfolio is opened, prompting input of new stock symbols and subjective data.

FIG. 13 illustrates screen shots of windows displayed to the subscriber when a Monitor portfolio is opened, prompting input of data on new positions and ALERT criteria.

FIGS. 14-16 are exemplary screen shots of a Monitor portfolio grid as displayed to the subscriber. In the illustrated embodiment, the Monitor portfolio is a Naked Put Monitor Portfolio.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

The preferred embodiments of the invention include the following software modules: 1) an Evaluator portfolio, 2) a Monitor portfolio and 3) a Portfolio Summary. The Evaluator comes in six separate versions depending on the trading strategy employed by the subscriber. Each Evaluator uses a different scoring formula based on whether or not the strategy is bullish or bearish and whether or not the strategy involves the sale or purchase of options. Each Evaluator aggregates the objective value, growth and technical data and combines it with subjective data inputted by the subscriber in order to score investment opportunities taking into account the individual's own investment philosophy, i.e. value, growth or technical and their individual trading strategy(s).

The Monitor maintains a record of the investor's current positions and, in the case with certain option strategies, provides relevant data to indicate potential closeout candidates. It also calculates the amount of index puts to buy to “insure” a position against a market correction.

The Portfolio Summary maintains a summary of the investor's total market positions based on all of their trading strategies.

Although no one knows the future direction of any stock price, there are certain indicators, depending on investment philosophy, which may aid in that prediction. For instance, value investors look to a company's price to earnings, book value, and the like, as a key to the stock's future direction. Growth investors look to a company's earnings per share growth rate and PEG (Price to Earnings to Growth) ratio. Technical investors may look to the stock's historical price movement as a prime indicator. The system aggregates data relevant to each of these philosophies and allows the investor to weight each factor in arriving at an overall investment opportunity score.

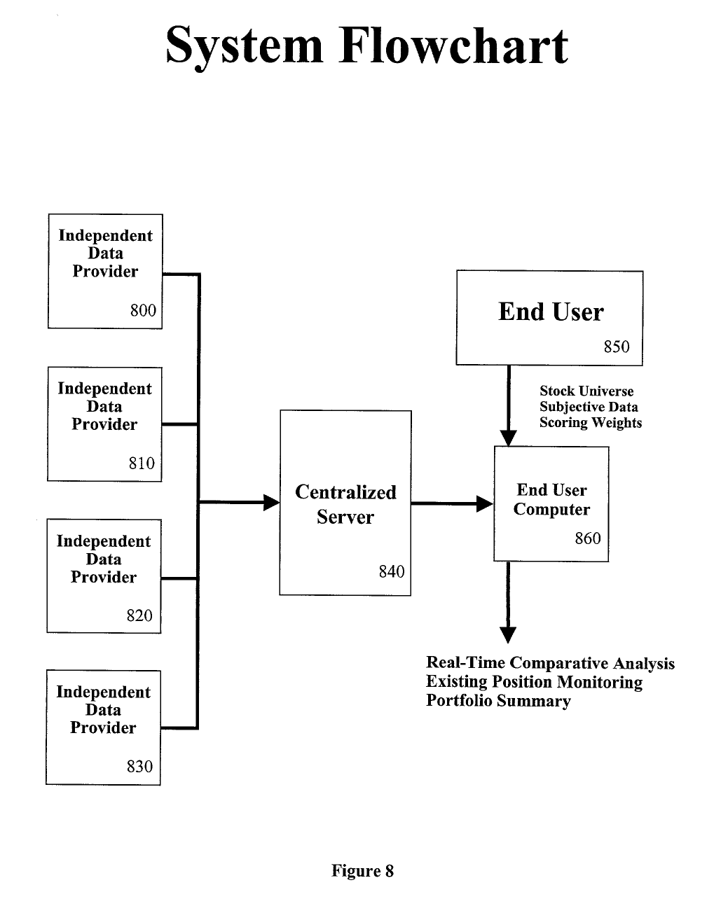

As shown in FIG. 8, in a preferred embodiment of the system and method, three or more computer systems are involved, including a centralized server 840 operated by a service provider, one or more independent data provider (IDP) servers 800-830, and a subscriber's computer 860, upon which resides software including the Evaluator, Monitor, and Portfolio Summary modules described above. In an alternative embodiment, the software including the Evaluator, Monitor, and Portfolio Summary modules resides upon the centralized server 840, and is accessible to the subscriber's computer 860 via, e.g., an Internet, dial-up, network, or other connection. In yet another embodiment, a single server performs the functions of the IDP server 800 and the centralized server 840. In a further embodiment, a single server performs the functions of the centralized server 840, independent data provider servers 800-830, and a subscriber's computer 860.

The Evaluator

The system starts, in a preferred embodiment as illustrated in FIG. 8, by having the centralized server 840 aggregate value, growth and technical data for most domestically traded stocks, as well as current stock and option prices, obtained, e.g., through an Internet, dial-up, network, or other connection, from one or more independent data providers 800-830. The subscriber's computer 860, through an Internet connection to the centralized server 840, calls for this objective data from the centralized server 840 for various stocks, i.e., the subscriber's stock universe, which have been inputted into a particular Evaluator portfolio residing in the subscriber's computer 860. The objective data is transferred from the centralized server 840 to the subscriber's computer 860, where the Evaluator module displays the data in rows in a spreadsheet-like grid on the subscriber's computer screen 860.

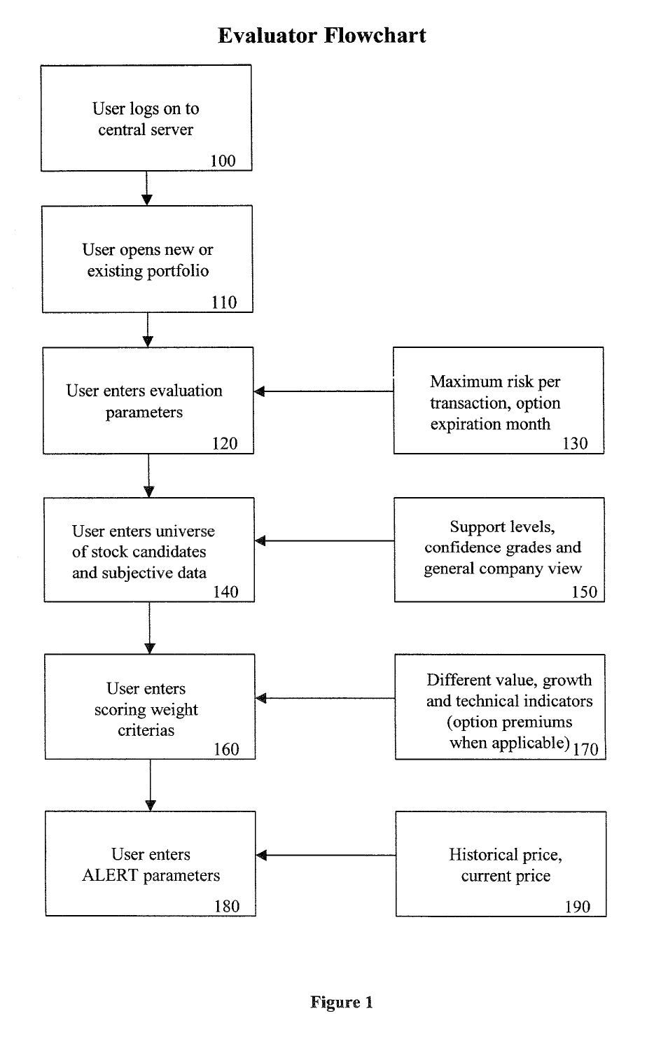

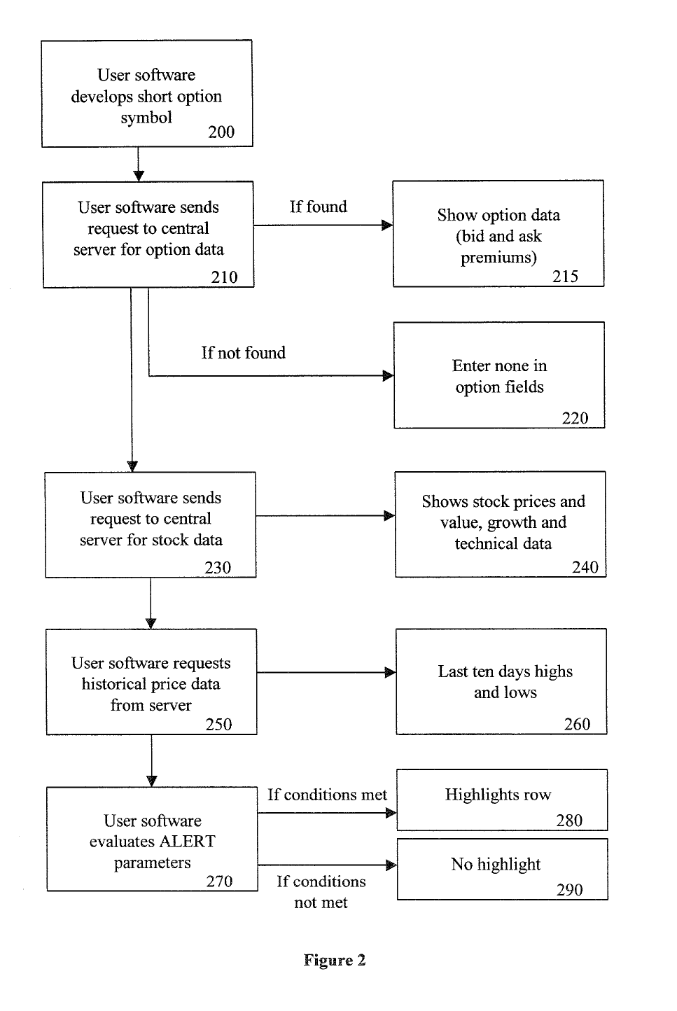

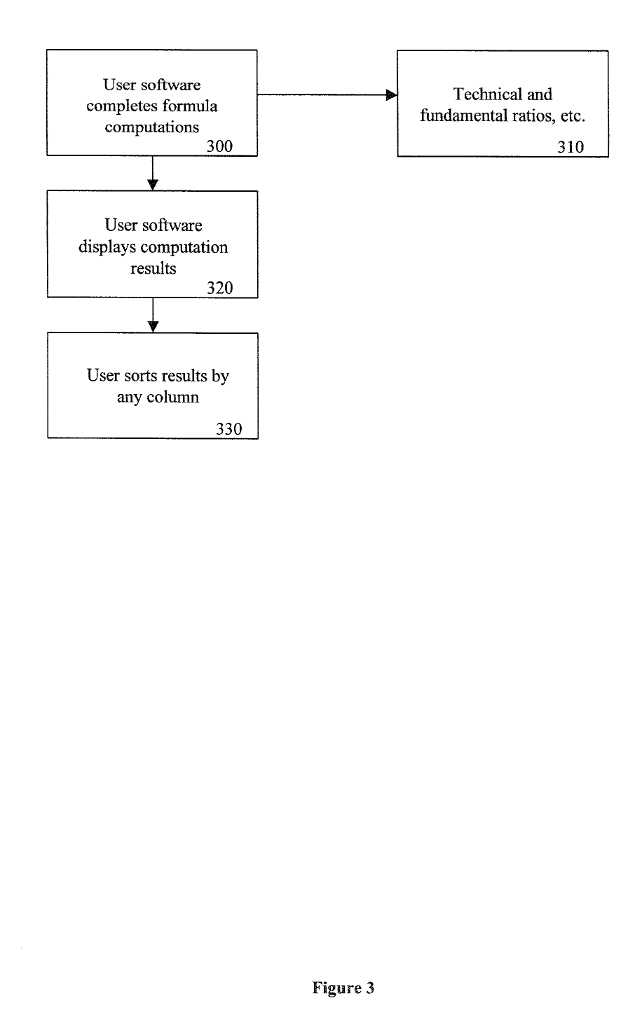

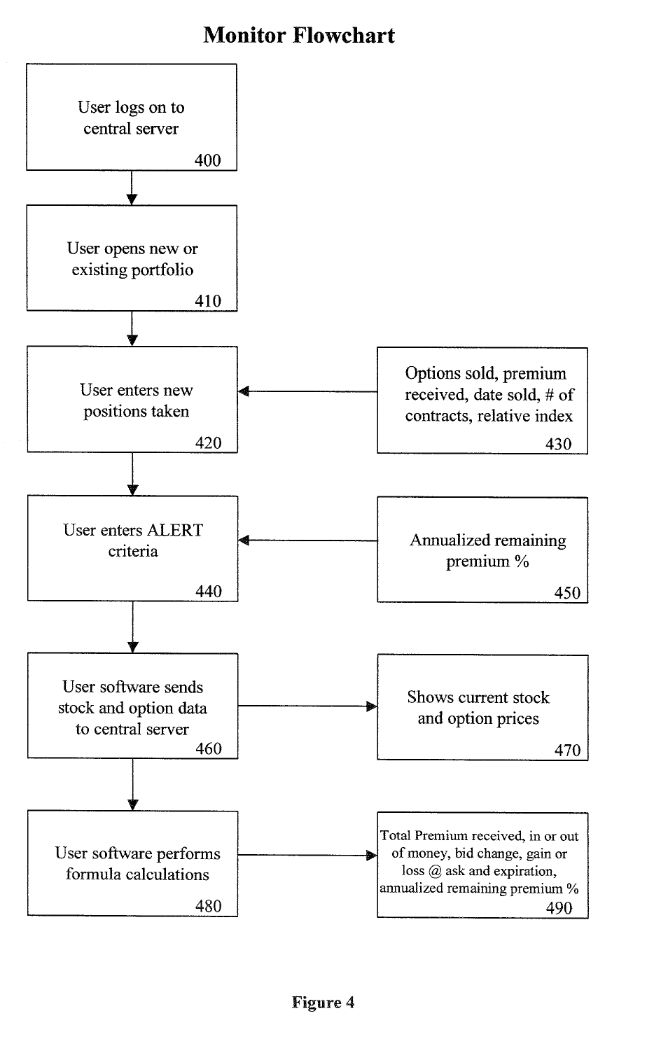

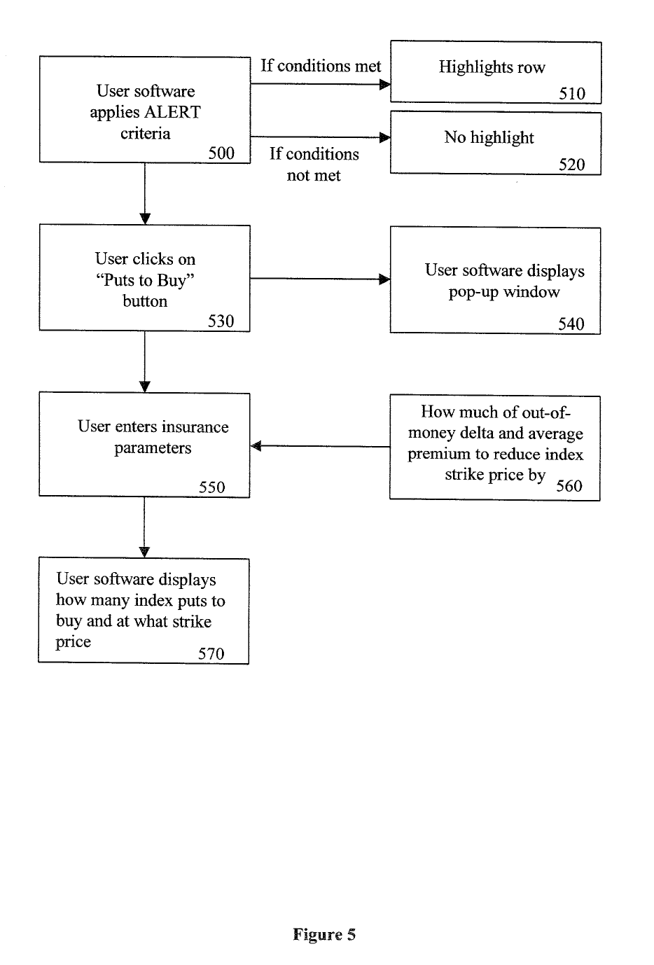

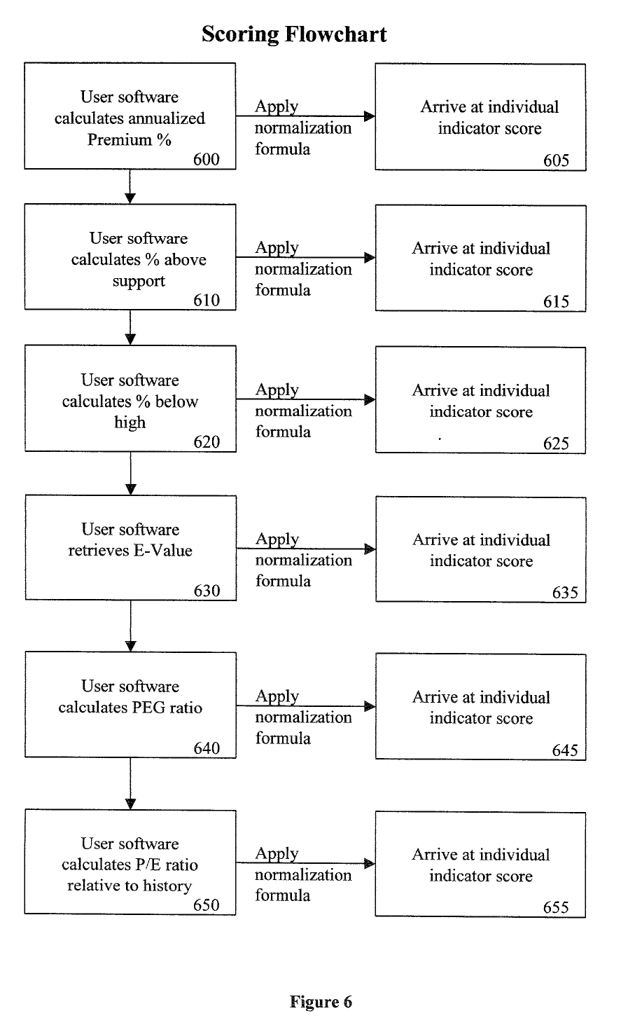

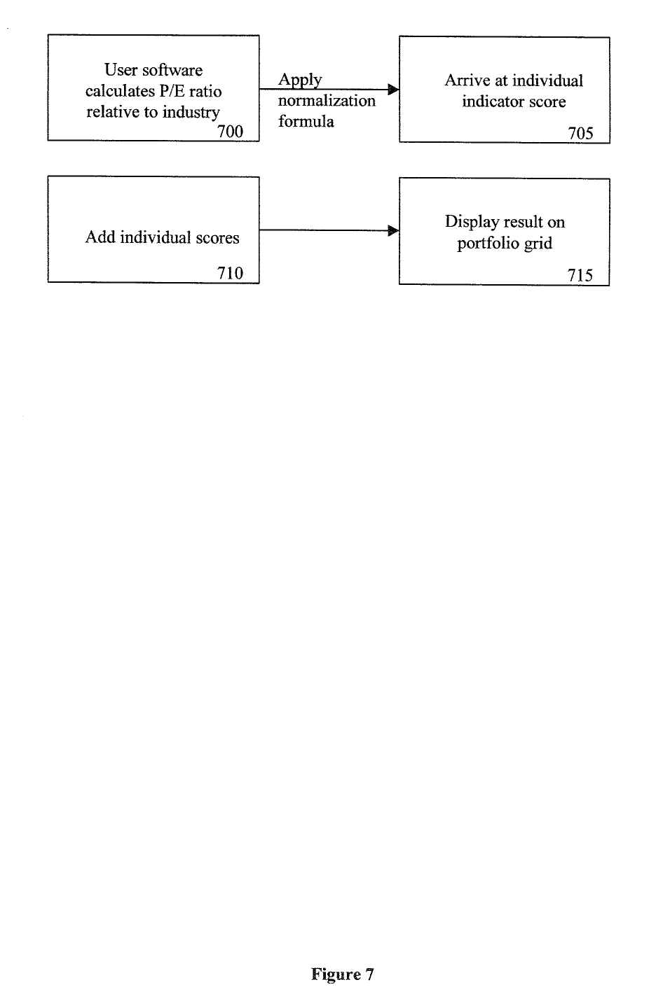

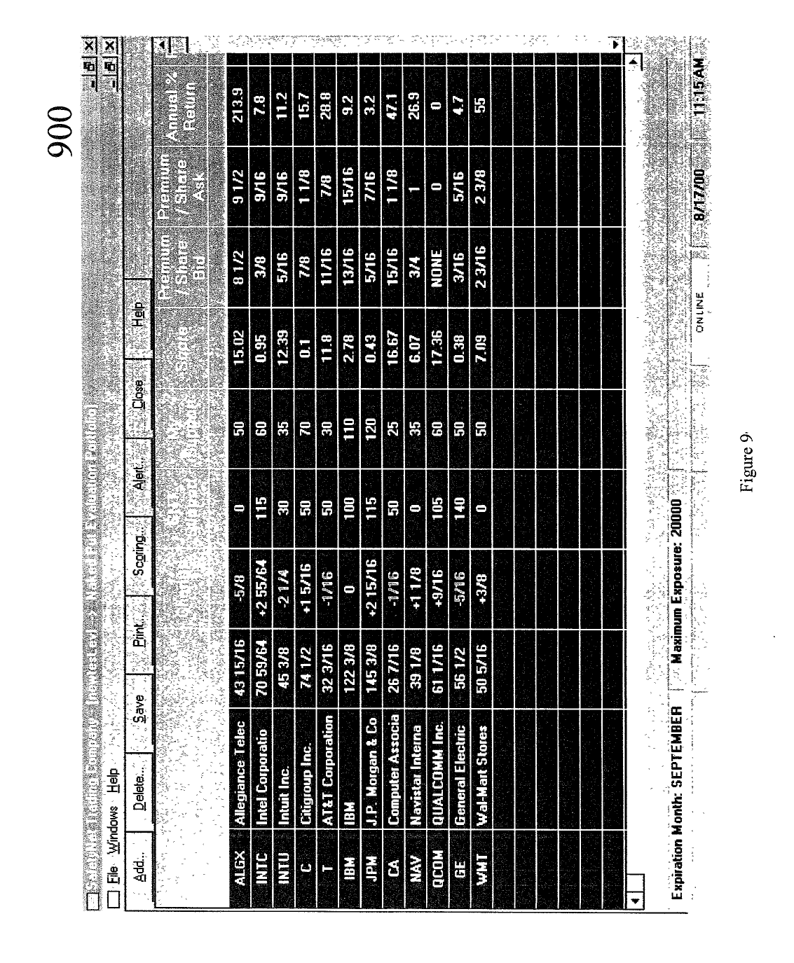

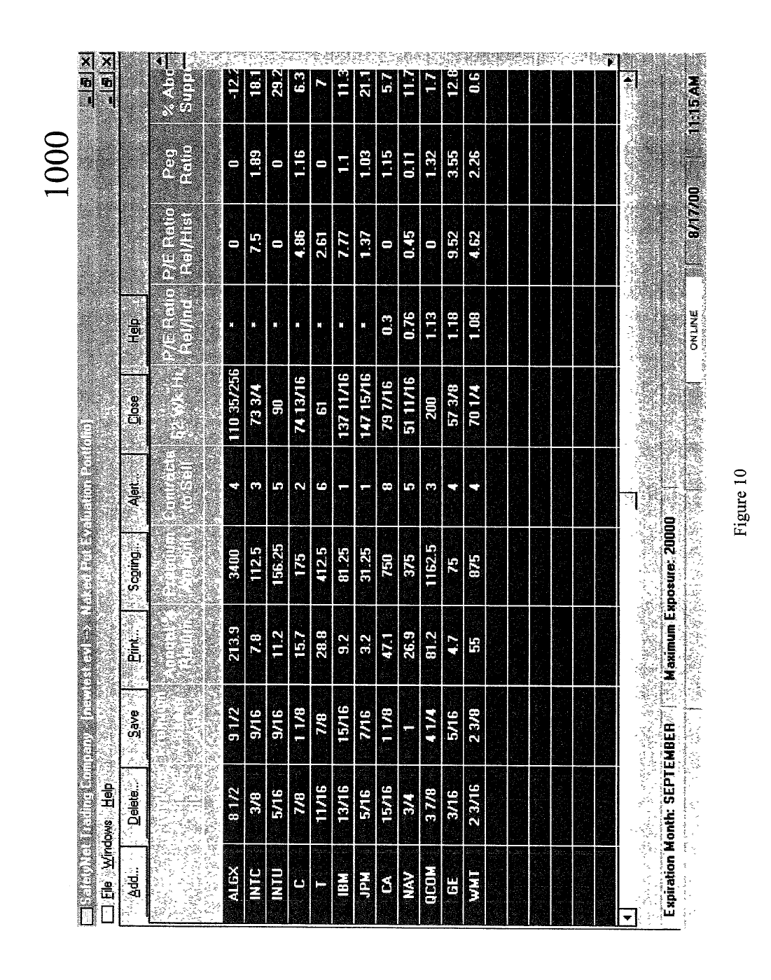

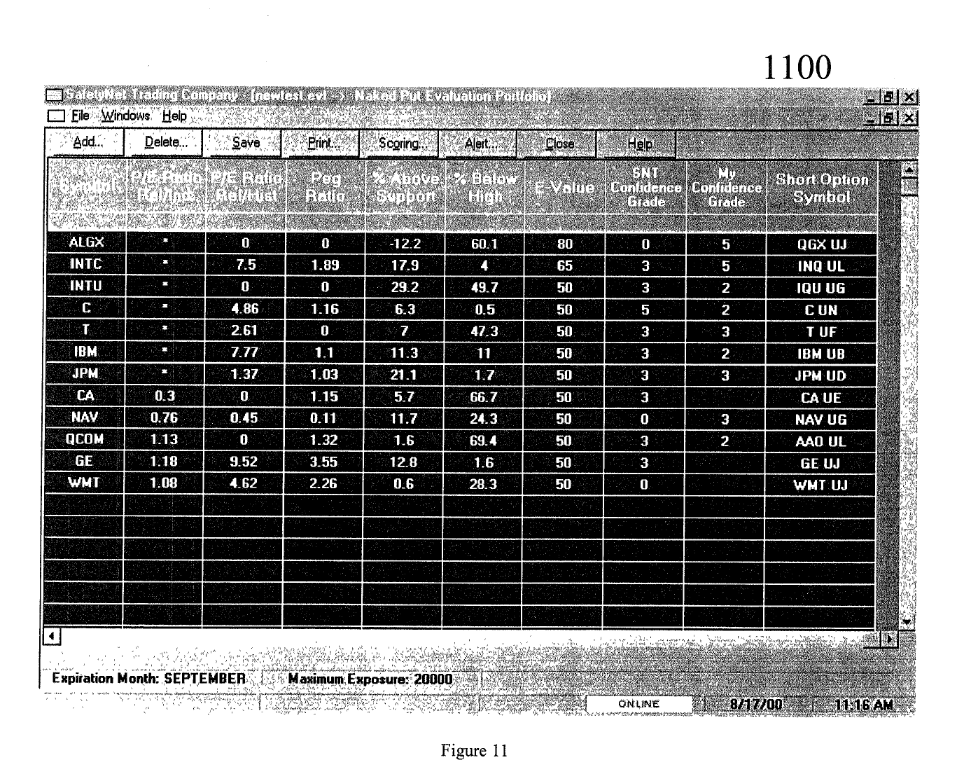

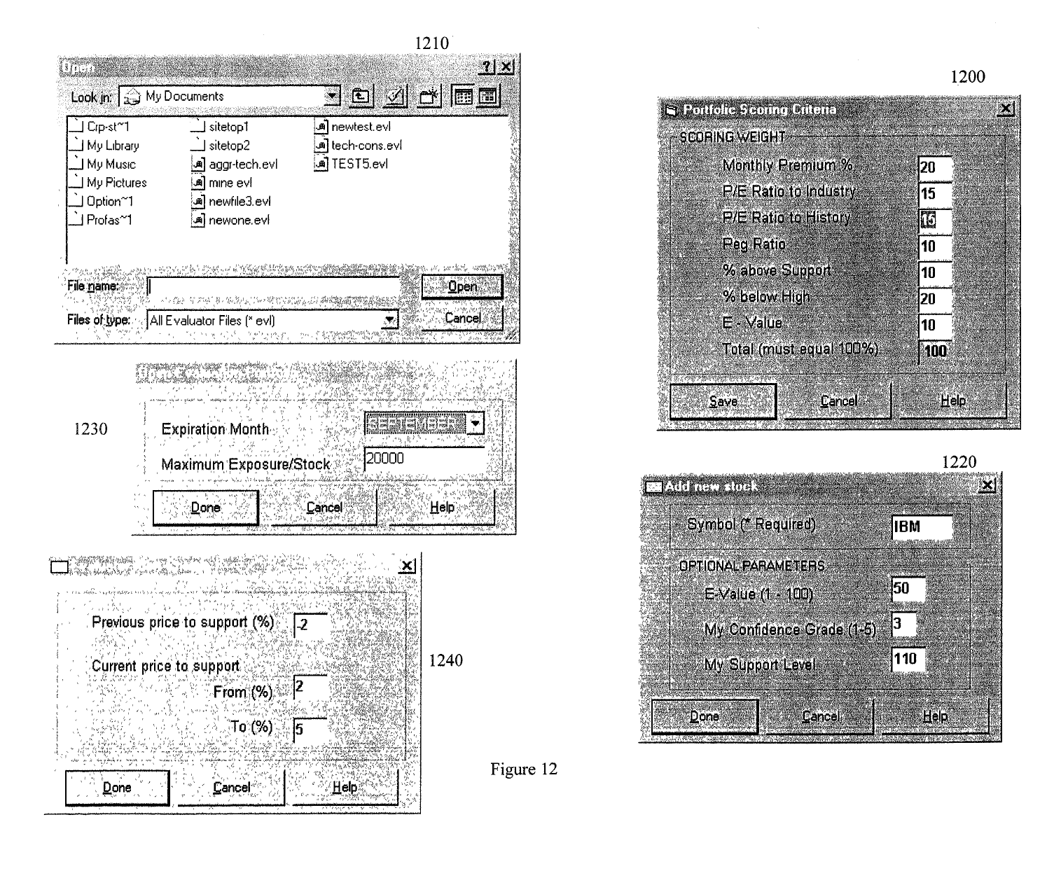

The steps performed by the Evaluator module in a preferred embodiment are illustrated in FIG. 1. Once the Evaluator software is installed on a computer system, it allows the subscriber to log onto the centralized system 100. When the subscriber 850 logs on to the centralized server 840 via his or her computer 860, he or she is prompted to open a new or existing Evaluator portfolio 110 from the “open” window dialog box 1210 shown in FIG. 12. If an existing Evaluator portfolio is opened, the previously entered evaluation portfolio entries are displayed as the default. The subscriber is then prompted to enter evaluation parameters 120, 1230 shown in FIG. 12. These parameters include the maximum risk the subscriber is willing to assume for a specific transaction, i.e., a dollar amount, and, in the case of option strategies, the option expiration month wished to be evaluated 130. After the parameters are inputted, a grid and toolbar 900, 1000, 1100 shown in FIGS. 9, 10, and 11 are displayed. An existing portfolio would immediately display previously entered stocks and the corresponding data. Examples of such data are the following: Stock Symbol (from subscriber); Company Name (from IDP); Price per share (from IDP), Last traded price (from last close, from IDP); Change in Price (from last close, from IDP); SNT Support (provided by the service provider (i.e., SafetyNet Trading or “SNT”) for a universe of stocks which have been selected from the top holdings of the best performing mutual funds); My Support (from subscriber); Score (calculated from the inputted subjective and objective data); Premium/Share Bid (from IDP); Premium/Share Ask (from IDP); Annual % Return (calculated from data provide by IDP); Premium Amount (calculated from data provide by IDP and maximum risk entered by subscriber); Contracts to Sell (calculated from maximum risk entered by subscriber); 52 Week High (from IDP); P/E Ratio Rel/Ind.(from IDP); P/E Ratio Rel/His. (from IDP); PEG Ratio (from IDP); % Above Support (from service provider, unless subscriber enters a support level); % Below High (calculated from data provided by IDP), E-Value (from subscriber); SNT Confidence Grade (from service provider); My Confidence Grade (subscriber enters an optional confidence grade); and Short Option Symbol (from IDP). Additional indicators could be added, however, the current set of indicators includes those believed to be the most important to calculating a meaningful score. A new portfolio would display an empty grid. The subscriber may add new stocks to be evaluated to either an existing or new portfolio 140. To add a new stock to the Evaluator Portfolio, the subscriber clicks on the “ADD” button, which results in the display of a pop-up window 1220 shown in FIG. 12. At this point the subscriber enters the stock symbol, E-value (a number between 1-100 which represents the subscriber's overall feeling about the company, wherein a score greater than 50 indicates positive feeling, less than 50 indicates negative feeling, and approximately 50 is neutral), the subscriber's suggested support level for the stock, and his or her confidence grade for that support level 150. The subscriber establishes a scoring criteria for the particular Evaluator Portfolio by clicking on the “Scoring” button which displays a pop-up window 1200 containing the indicators used in the scoring process, including Monthly Premium %, P/E Ratio to Industry, P/E Ratio to History, PEG ratio, % above support, % below High, and E-value 170. The subscriber enters a percentage value (a weighting factor) for all indicators 160 which will be used to score the investment opportunities for each stock in the Evaluator Portfolio. The sum of the weighting factors entered for all indicators must equal 100%, otherwise an error message appears. The subscriber will assign higher percentage values to those indicators deemed to be of greater importance or more weight and lower percentage values to those indicators deemed to be of lesser importance or lesser weight.

In one embodiment of the invention, the stocks in a particular Evaluator Portfolio do not share common characteristics, i.e., technology stocks, cyclicals, and the like, such that the scoring criteria inputted by the subscriber are applicable to all stocks in that portfolio. In another embodiment of the invention, the subscriber may set up multiple portfolios, each having a different set of scoring criteria tailored to the collection of stocks which share common characteristics contained within each portfolio. The system permits this customized scoring for each portfolio of different type stocks. Alternatively, the subscriber may modify portfolios comprising a set of pre-selected stocks and pre-selected set of scoring criteria. Such portfolios may be available for downloading from the central server, or may be included within the software installed on the subscriber's personal computer.

The scoring process begins by applying a formula to each indicator in order to normalize the numbers relative to each indicator. That is accomplished by first considering a reasonable range for the data. One Evaluator portfolio is a Naked Put Evaluator. In the Naked Put Evaluator, it is assumed that a reasonable range for the annualized premium % is 27-60%. This range is based on the service provider's analysis of a range that would be reasonable to evaluate. Options outside of this range are typically not acceptable positions. Since the data are normalized to the number “five”, the formula for this indicator is the “annualized premium %” times “11.5”. As a result the low range score will be approximately “3.1” and the high range score will be “6.9”. The average score will, of course, be “5”, i.e., the normalized number. The % above support is normalized to a value above 5 because it also includes the confidence factor.

This process is repeated for each indicator until each indicator has its own normalized value 600-705. The last step in the process is to apply the scoring criteria (weighting factors) entered by the subscriber for all indicators used in the scoring process, including Monthly Premium %, P/E Ratio to Industry, P/E Ratio to History, PEG ratio, % above support, % below High, and E-value, then total the score for all indicators 710. The following Table illustrates the scoring formulas for the applicable indicators in the Naked Put Evaluator, wherein CG=Support Level Confidence Grade; X=Indicator Value; if the P/E Indicators=0, then score=0; if the P/E Indicators Score is negative, then score=0; and if “% Above Support” is negative, then do not multiply by CG.

TABLE

| | | | Low | High |
|---|---|---|---|---|
| | Reasonable | | Range | Range |
| Indicator | Range | Formula | Score | Score |
| Annualized Prem. % | 27-60% | X × 11.5 | 3.1 | 6.9 |
| % Above Support | 0-15% | (X × 44) × | 0.0 | 16.5 |
| | | (0.5 × CG) | | |
| % Below High | 10-30% | X × 25 | 2.5 | 7.5 |
| E-Value | 50-100 | X/15 | 3.3 | 6.6 |
| PEG Ratio | 1-3 | (5 − X) × 1.67 | 3.3 | 6.6 |
| P/E Relative to History | 3-7 | (10 − X) | 3.0 | 7.0 |
| P/E Ratio to Industry | 0.75-2.25 | (4 − X) × 2 | 3.5 | 6.5 |

The subscriber may also enter an ALERT criteria which advises the subscriber when a stock's historical price movement falls within certain parameters 180, e.g., by highlighting the stock's row in the grid. This feature requires the subscriber to enter an historical price target, which the stock must have met, and then a current stock range the stock price must currently be in 190 on the ALERT pop-up window 1240. This feature may be used by an subscriber who would like to be notified when a stock price has fallen below the stock's support level within the last ten days and is currently between, e.g., 2-5%, above the support level, as shown in 1240. This may substantiate the previously set support level, i.e., a price at which the stock becomes attractive to other buyers and normally begins to rise, and indicate a breakout higher.

The portfolio grid and toolbar 900, 1000, 1100 has rows and columns which contain all the above referenced data, including real-time stock and option prices, and the overall score for each investment opportunity. The software can be used in two formats: real-time or delayed. In the real-time mode, the data is constantly updated based on what has been entered. In the delayed mode there is a “refresh button” that is be clicked in order to get new data from the central server. The objective data is retrieved from the central server by first assembling the short option symbol 200. This is done by aggregating the stock symbol, the month being evaluated and the support level (which acts as the strike price)- all of which are inputted by the subscriber. The short option symbol is generated using a look-up table. This compilation is sent to the central server, which requests the data from the independent data producer providing option prices 210. If no option exists, the grid displays a “none” in the price column 220. If an option exists, the appropriate option premiums are displayed 215.

The subscriber's software then sends a request for objective stock data to the central server 230 which then displays the relevant data 240 on the subscriber portfolio grid 900, 1000, 1100. Next, if an ALERT is set, the subscriber software requests the high and low trades for the past ten days 250 to determine whether or not the historical price movement alert has been met 260. The software then evaluates the historical price movement data and the stock's current price to see whether or not both ALERT parameters have been met 270. If the conditions have been met a highlight bar covers the appropriate row 280. No highlight is shown if both conditions have not been met 290.

The subscriber's software then performs all of the formula calculations based on the data received and posts the results to the appropriate grid cells 300, 310, 320.

The grid may be sorted by the values in any column, but is usually sorted by descending order of the overall Score in order that the best, objectively evaluated positions come to the top 330. The score updates automatically as real time price and other data changes during market hours. The scoring is, of course, static after the market closes, permitting after-hours analysis.

The Monitor

The Monitor is used to display the current status of existing “short” put or call positions. Subscribers sell out of the money puts or calls on stocks which are indicated by the data to either move up (in which case puts would be sold) or down (calls would be sold). The system also recommends the purchase of index options on a relative index to hedge against a major market correction (in the case of sold puts) or an enthusiastic rally (in the case of sold calls). One function of the Monitor is to quantify how many index options should be purchased in order to properly “insure” the portfolio and at what appropriate strike price.

As with the Evaluator, the subscriber logs on to the central server 400 and opens a new or existing Monitor Portfolio 410 from the “open” dialog window 1300. The subscriber may then enter new positions 420 by clicking the “ADD” button displayed on the Monitor grid toolbar 1400. The input window 1320 is then displayed requesting the subscriber to enter data regarding the new position taken 430. The subscriber then enters relevant data regarding the newly established position, including the option sold (entered by inputting the Stock Symbol, Expiration Month, and Strike Price), Date Opened, Premium/Share Received, Number of Contracts (converted to Number of Shares for display), Stock Price When Opened, and the Relative Index. The Relative Index is that market index which the subscriber feels will move most closely to the stock price of the underlying security for which a put or call was sold, e.g., DJX (Dow-Jones Industrial Average Index), QQQ (NASDAQ 100 Trust Index), SPX (S&P 500 Index), or HHH (ML Internet Index).

The subscriber may also enable an ALERT function in the Monitor by clicking on the ALERT button on the Monitor grid toolbar 440, 1400. This button activates a pop-up window 1330 which permits the subscriber to enter the maximum value of remaining annualized premium % 450 (calculated by dividing the current “option ask price” (the amount the subscriber would have to pay to close the position) by the strike price to determine the remaining premium %, then calculating an annualized premium amount based on that value) before they are alerted to a potential close-out of the position by highlighting the row in the grid. A subscriber may wish to close out such a position once the remaining profitability falls below that available from placing a new position. The potential profitability from a new position is calculated by an Evaluator portfolio as indicated above.

The subscriber's software then sends the stock and option data to the central server 460, which sends back the required data to populate the Monitor grid 470. This data includes Put Bid, Put Ask, Put Last, Current Price, Change, and Bid Change. The software then performs the formula calculations 480 and displays the results in the appropriate cells 1400, 1500, 1600. The calculated results include In or Out Money, Gain/Loss at Ask, Gain/Loss at Expiration, Total Premium Received, and Remaining Premium %.

The Monitor indicates, based on the current stock and option prices, the subscriber's current profit or loss on each position and the ultimate profitability at the option's expiration if the stock stays at least level to expiration. Most importantly, the Monitor evaluates the remaining profitability of the option position 490, which helps indicate if the position should be closed out in favor of placing a more profitable one, based on new opportunities displayed on one of the Evaluator portfolios. As mentioned above, the subscriber may establish an ALERT criteria which the software applies to the entries in the Monitor portfolio 500 and then displays an appropriate highlight 510 on the Monitor grid if and when the ALERT criteria has been satisfied, or else no highlight is displayed if the ALERT criteria is not satisfied 520.

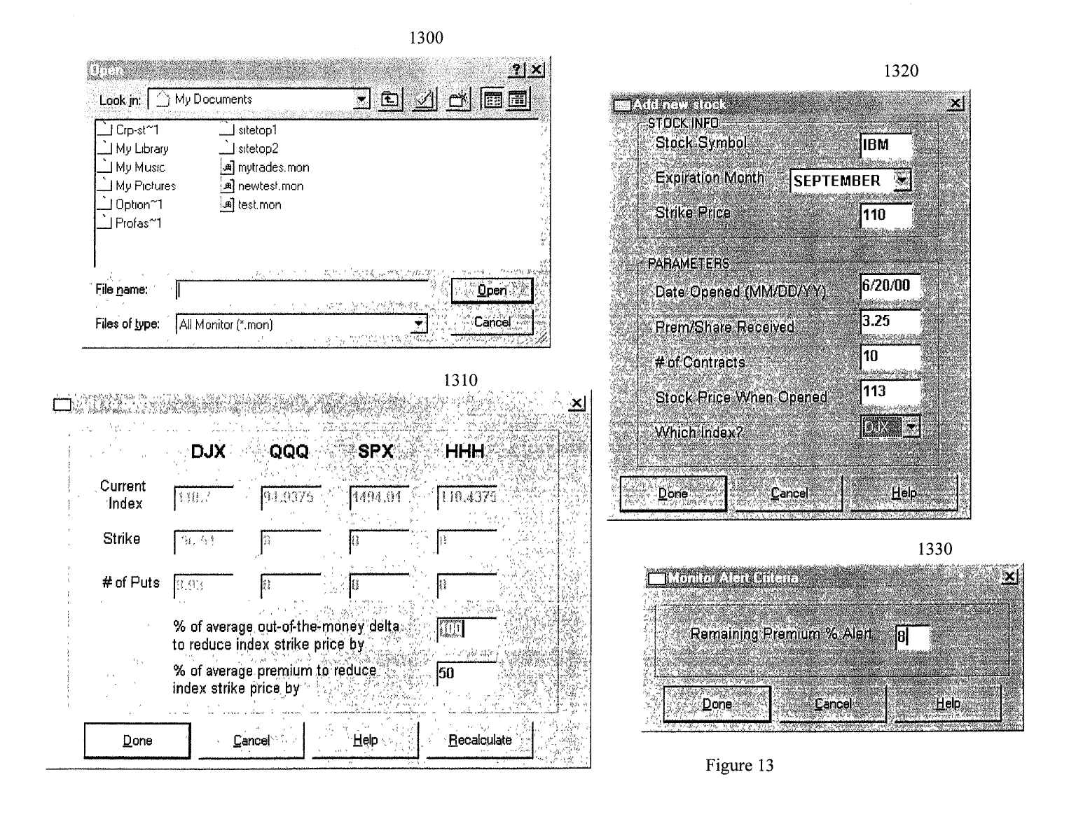

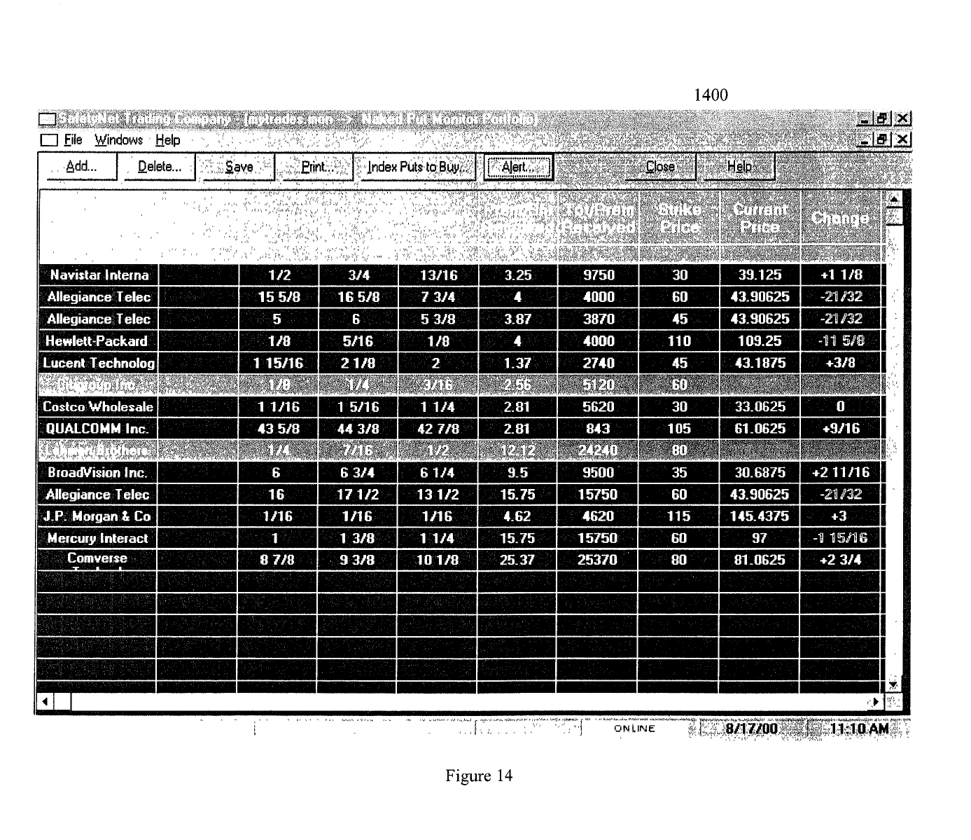

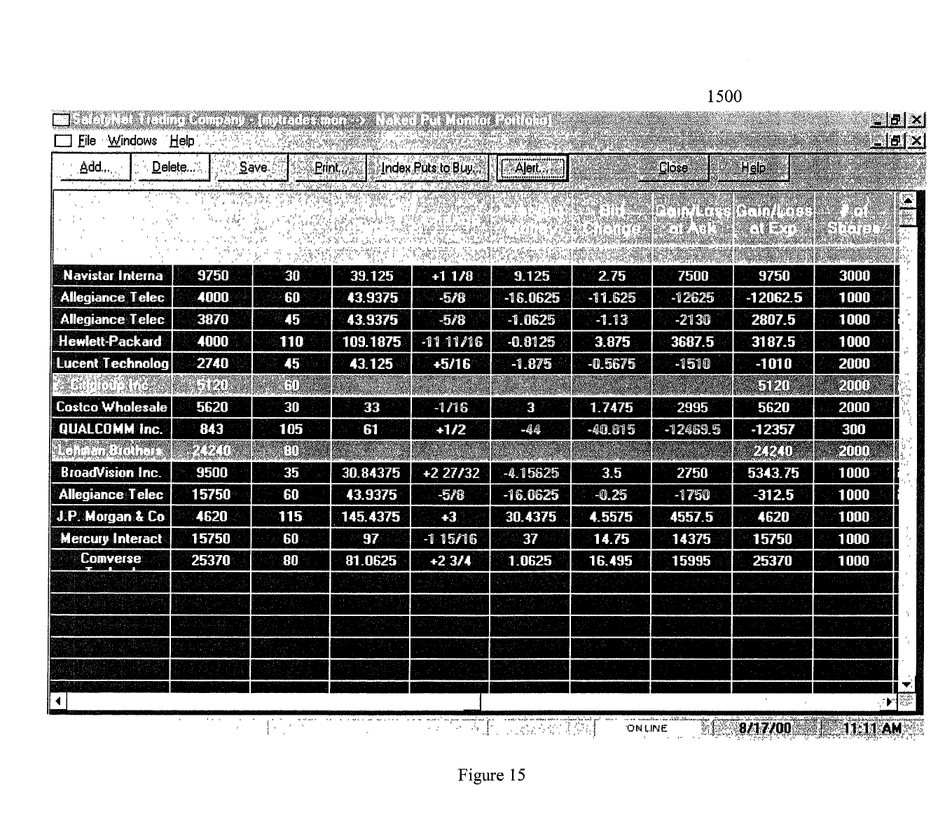

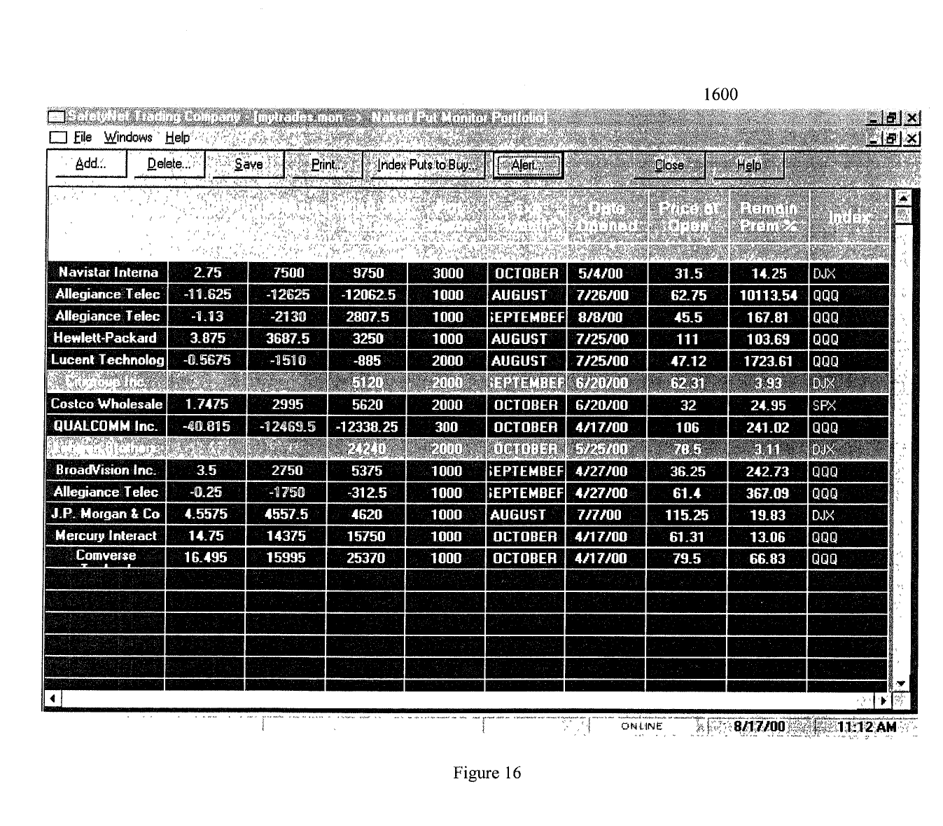

Lastly, the put index calculator is accessed by clicking on the “Puts to Buy” button 530. This causes the subscriber software to display a pop-up window 540, 1310 which permits the subscriber to enter the appropriate criteria for the calculation 550. In this case, the subscriber will enter what percentage of the average difference between the equity put strike price and the current stock price (out-of-the-money delta) of the underlying security should be used to reduce the index strike price and what percentage of the average option premium received should be used to further reduce the index strike price 560. Based on those entries, along with the previously inputted subscriber data, the subscriber's software calculates the result 570 and displays it on the pop-up window 1310. The calculated result includes the strike price and number of puts that should be purchased for the particular index based on the previous subscriber input of investment positions. As shown in FIG. 13, four indices are available: DJX (Dow-Jones Industrial Average Index), QQQ (NASDAQ 100 Trust Index), SPX (S&P 500 Index), or HHH (ML Internet Index). However, the method is not limited to these indices. Any index for which puts may be purchased may be used in the method and system.

The above description discloses several methods and systems of the present invention. This invention is susceptible to modifications in the methods and systems. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A system for the comparative analysis of investment opportunities comprising:
a. a computer processor;
b. a computer storage medium;
c. data stored in said computer storage medium;
d. said computer processor performing the steps of:
i) initializing the storage media;
ii) processing subjective data from an investor for one or more companies for which stocks or options are traded;
iii) processing objective data from an independent data provider for each company for which subjective data is available;
iv) aggregating the subjective data and objective data and calculating a score for each stock or option for which subjective data is available, said score being indicative of the quality of the investment opportunity in the stock or option.

2. The system of claim 1, wherein the computer processor comprises a centralized server accessible by an investor's personal computer via an Internet or dial-up connection.

3. The system of claim 2, wherein the subjective data is inputted to the centralized server from the investor's personal computer via an Internet, dial-up, or network connection.

4. The system of claim 1, wherein the computer processor comprises a centralized server having access to an independent data provider's computer system via an Internet, dial-up, or network connection.

5. The system of claim 4, wherein the objective data is inputted to the centralized server from the independent data provider's computer system via an Internet, dial-up, or network connection.

6. The system of claim 1, wherein the subjective data comprises one or more stocks and the maximum risk the investor is willing to assume for a specific investment transaction.

7. The system of claim 1, wherein the subjective data further comprises an option expiration month to be analyzed.

8. The system of claim 1, wherein the subjective data further comprises a stock symbol, a support level for the stock, and a confidence grade for the support level for the stock, and an E-value for the stock, wherein the E-value indicates the investor's positive, neutral, or negative feeling for the company.

9. The system of claim 1, wherein the subjective data includes a weighting factor for one or more objective data.

10. The system of claim 1, wherein the objective data comprises value, growth and technical data for domestically traded stocks or options.

11. The system of claim 1, wherein the objective data is selected from the group consisting of price per share, last traded price, change in price, premium per share bid, premium per share ask, annual percent return, 52 week high, price to earnings ratio relative to an index, price to earnings ratio relative to history, price to earnings to growth ratio, and percent below high.

12. The system of claim 1, wherein the objective data is selected from the group consisting of support level, percent above support, and confidence Grade.

13. The system of claim 11, wherein the objective data is provided by a service provider.

14. A method for the comparative analysis of investment opportunities in stocks or options comprising:
inputting two or more companies for which stocks or options are traded;
inputting an investor's subjective data, wherein said subjective data comprises weighting factors for objective value, growth or technical data for the companies and wherein the weighting factors are based on the investor's investment philosophy;
inputting objective data for the two or more companies, wherein said objective data comprises objective value, growth, or technical data;
calculating a score for each investment opportunity wherein said score is determined by applying the investor's weighting factors to the objective and subjective data, and wherein said score is indicative of the quality of investment in each position.

15. The method of claim 14, wherein said investment opportunity is analyzed from investment strategies selected from the group consisting of the sale of puts, the sale of calls, the purchase of puts, the purchase of calls, the purchase of stock, the short sale of stock and credit put and call spreads.

16. The method of claim 14, wherein the subjective data comprises the maximum risk the investor is willing to assume for a specific investment transaction.

17. The method of claim 14, wherein the investment opportunity is in options and the subjective data further comprises an option expiration month.

18. The method of claim 14, wherein the subjective data further comprises a support level for the stock, a confidence grade for the support level for the stock, and an E-value for the stock, wherein the E-value indicates the investor's positive, neutral, or negative feeling for the stock.

19. The method of claim 14, wherein the objective data is selected from the group consisting of price per share, last traded price, change in price, premium per share bid, premium per share ask, annual percent return, 52 week high, price to earnings ratio relative to an index, price to earnings ratio relative to history, price to earnings to growth ratio, and percent below high.

20. The method of claim 14, wherein the objective data further comprises service provider objective data selected from the group consisting of support level, percent above support level, and confidence grade in the support level.

21. The method of claim 14, wherein said investment opportunity is in an option, further comprising:
inputting newly established investment position data;
calculating a maximum value of remaining annualized premium percentage based on objective technical data;
alerting the investor if the annualized premium percent drops below the maximum value of remaining annualized premium percent.

22. A method for facilitating the comparative analysis of investment opportunities in stocks or options by an investor comprising:
inputting, at an investor's personal computer, two or more-companies for which stocks or options are traded;
inputting, at the investor's personal computer, subjective data, wherein said subjective data comprises weighting factors for objective value, growth or technical data for the stocks or options and wherein the weighting factors are based on the investor's investment philosophy;
receiving, at the investor's personal computer, objective data for the two companies, wherein said objective data comprises objective value, growth, or technical data;
calculating, at the investor's personal computer, a score for each stock or option, wherein said score is determined by applying the investor's weighting factors to the objective data, and wherein said score is indicative of the quality of investment in each stock or option.

23. The method of claim 14, wherein said investment opportunity is analyzed by strategies selected from the group consisting of the sale of puts, the sale of calls, the purchase of puts, the purchase of calls, the purchase of stock, the short sale of stock, and credit put and call spreads.

24. The method of claim 14, wherein the subjective data comprises the maximum risk the investor is willing to assume for a specific investment transaction.

25. The method of claim 14, wherein the investment opportunity is in options and the subjective data further comprises an option expiration month.

26. The method of claim 14, wherein the subjective data further comprises a support level for the stock, a confidence grade for the support level for the stock, and an E-value for the stock, wherein the E-value indicates the investor's positive, neutral, or negative feeling for the stock.

27. The method of claim 14, wherein the objective data is selected from the group consisting of price per share, last traded price, change in price, premium per share bid, premium per share ask, annual percent return, 52 week high, price to earnings ratio relative to an index, price to earnings ratio relative to history, price to earnings to growth ratio, and percent below high.

28. The method of claim 14, wherein the objective data further comprises service provider objective data selected from the group consisting of support level, percent above support level, and confidence grade in the support level.

29. The method of claim 14, wherein said investment opportunity is in an option, further comprising:
inputting, at the investor's personal computer, newly established investment position data;
calculating, at the investor's personal computer, a maximum value of remaining annualized premium percentage based on objective technical data;
alerting the investor, at the investor's personal computer, if the annualized premium percent drops below the maximum value of remaining annualized premium percent.
